(19) United States
(12) Patent Application Publication
(10) Pub. No.: US 2019/0102082 A1
(43) Pub. Date: Apr. 4, 2019

(54) TOUCH-SENSITIVE ALPHANUMERIC USER INTERFACE

(71) Applicant: Valeo North America, Inc., Troy, MI (US)

(72) Inventors: Siav-Kuong Kuoch, Troy, MI (US); David Saul Hermina Martinez, Troy, MI (US)

(73) Assignee: Valeo North America, Inc., Troy, MI (US)

(21) Appl. No.: 15/723,546

(22) Filed: Oct. 3, 2017

(51) Int. Cl. G06F 3/0488; G06F 3/041; G06F 3/0354; G06F 3/0484

(52) U.S. Cl. CPC G06F 3/04886; G06F 3/0416; G06F 3/04883; B60K 2350/928; G06F 3/04842; B60K 2350/1024; B60K 2350/352; G06F 3/03547

(57) ABSTRACT

A touch-sensitive alphanumeric user interface for a vehicle. The touch-sensitive alphanumeric user interface includes a touchpad, a touchpad interface unit, a display interface unit and a display. The touchpad is integrated in a steering wheel of the vehicle and obtains coordinates of a trajectory performed by a finger of a user of the vehicle. The touchpad interface unit determines that a finger movement, identified from the first coordinates, is an arcuate movement, and based on the determination, issues arcuate movement instructions to the display interface unit. The display interface unit renders a visualization of alphanumeric choices, arranged in a circular pattern, determines a selected alphanumeric choice from the alphanumeric choices, based on the arcuate movement instructions, and renders the selected alphanumeric choice to be highlighted. The display, which is spatially separate from the touchpad, displays the rendered visualization of the alphanumeric choices and of the selected alphanumeric choice.

### BACKGROUND

Vehicles are increasingly equipped with infotainment systems that require alphanumeric input by a user, e.g., the driver of the vehicle. The alphanumeric input may be provided via a hand-operated input device in the vicinity of the user. Such input may be provided via a traditional keyboard displayed near the user, via voice command, or via hand writing recognition technology.

### SUMMARY

In general, in one aspect, the invention relates to a touch-sensitive alphanumeric user interface for a vehicle, comprising: a first touchpad, integrated in a steering wheel of the vehicle, and configured to obtain first coordinates of a first trajectory performed by a finger of a user of the vehicle; a touchpad interface unit configured to: make a first determination that a first finger movement, identified from the first coordinates, is an arcuate movement, and based on the first determination, issue arcuate movement instructions to a display interface unit; the display interface unit configured to: render a visualization of a plurality of alphanumeric choices, arranged in a circular pattern; determine a selected alphanumeric choice from the plurality of alphanumeric choices, based on the arcuate movement instructions; render the selected alphanumeric choice to be highlighted; and a display, spatially separate from the first touchpad, configured to: display the rendered visualization of the plurality of alphanumeric choices and of the selected alphanumeric choice.

In general, in one aspect, the invention relates to a method for operating an infotainment system of a vehicle, the method comprising: obtaining, using a first touchpad that is integrated in a steering wheel of the vehicle, first coordinates of a first trajectory performed by a finger of a user of the vehicle; making a first determination that a first finger movement, identified from the first coordinates, is an arcuate movement, and based on the first determination, issue arcuate movement instructions; rendering a visualization of a plurality of alphanumeric choices, arranged in a circular pattern; determining a selected alphanumeric choice from the plurality of alphanumeric choices, based on the arcuate movement instructions; rendering the selected alphanumeric choice to be highlighted; and displaying the rendered visualization of the plurality of alphanumeric choices and of the selected alphanumeric choice in a display.

### BRIEF DESCRIPTION OF DRAWINGS

FIG. 1 shows a touch-sensitive alphanumeric user interface, in accordance with one or more embodiments of the invention.

FIGS. 2A-2F show the touch-sensitive alphanumeric user interface while being operated by a user, in accordance with one or more embodiments of the invention.

FIG. 3 shows a flowchart illustrating a method for receiving and processing alphanumeric input, in accordance with one or more embodiments of the invention.

FIG. 4 shows a flowchart illustrating a method for interpreting detected finger movement to obtain a user interface action, in accordance with one or more embodiments of the invention.

### DETAILED DESCRIPTION

Specific embodiments of the invention will now be described in detail with reference to the accompanying figures. Like elements in the various figures are denoted by like reference numerals for consistency. Like elements may not be labeled in all figures for the sake of simplicity.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (e.g., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

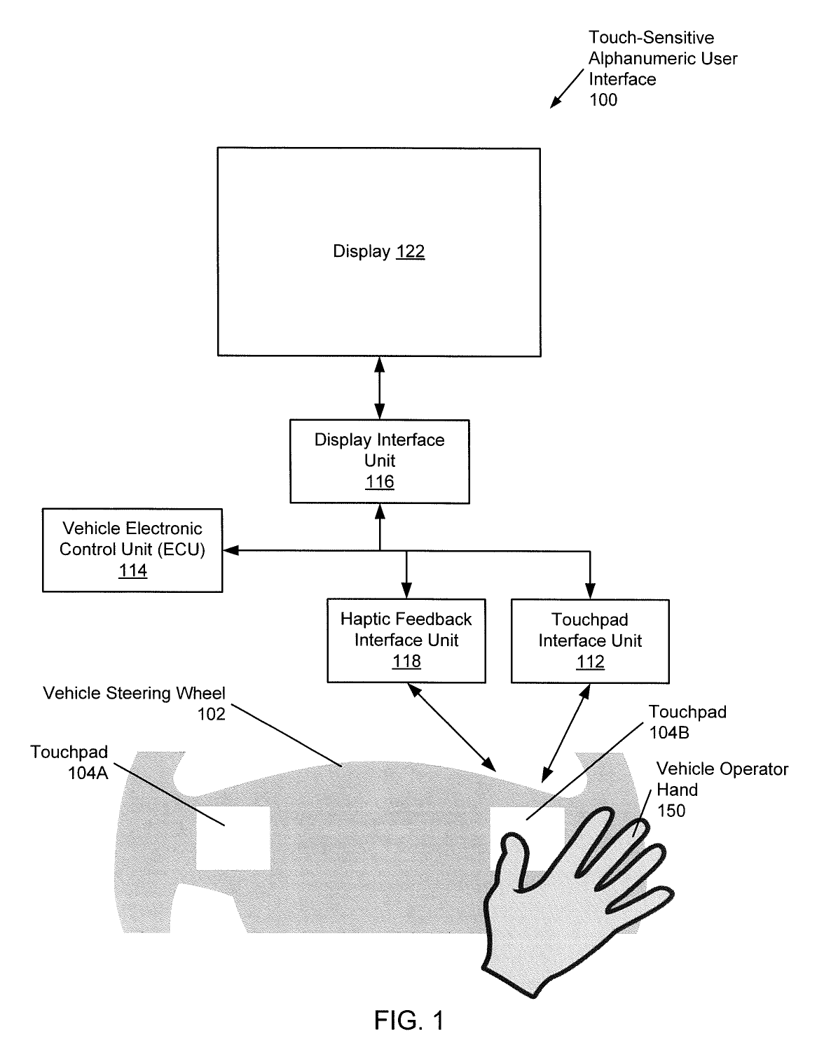

In the following description of FIGS. 1-4, any component described with regard to a figure, in various embodiments of the technology, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the technology, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that, one or more of the steps shown in the flowcharts may be omitted, repeated, and/or performed in a different order than the order shown. Accordingly, the scope of the invention should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

In general, embodiments of the technology are directed to methods and systems for enabling a user of a vehicle to enter alphanumeric content. Alphanumeric content may be used, for example, to control infotainment systems including navigation systems, radios, MP3 players, cell phones, etc. A touch-sensitive alphanumeric user interface, in accordance with one or more embodiments of the invention, separates the input device from the output device. More specifically, a touch-sensitive alphanumeric interface, in accordance with one or more embodiments of the invention, includes a touchpad that is installed in the vicinity of a vehicle driver's hands, and a display that is installed elsewhere. The display may be integrated in the instrument cluster, or it may be a head-up display (HUD) that enables the driver to view display content while focusing on traffic. Any other type of display or output device may also be used without departing from the teachings of the present disclosure.

Referring to FIG. 1, a touch-sensitive alphanumeric user interface, in accordance with one or more embodiments of the invention, e.g., a system (100), is shown. The system includes various components that are subsequently described.

In one embodiment of the invention, the system (100) includes a vehicle steering wheel (102). The steering wheel may be installed in any kind of vehicle, e.g., in a car or in a truck. The steering wheel, in accordance with an embodiment of the invention, is held by a vehicle operator's (e.g., driver's) hand(s) (150). Note that even though a steering wheel is shown in the system (100), the invention is not limited to vehicles that require continuous engagement of the driver. Rather, the invention may further be used in vehicles that offer various degrees of autonomous driving, ranging from partial driver assistance to full automation of the driving task. For example, the invention may be used with levels of vehicle autonomy, defined by the National Highway Traffic Safety Administration (NHTSA) (e.g., Level 0, where the driver is in full control of the vehicle; Level 1, where a driver assistance system controls steering or acceleration/deceleration; Level 2, where the driver assistance system controls steering and acceleration/deceleration, and where the driver performs all other aspects of the driving task; Level 3, where all aspects of driving are performed by the driver assistance system, but where the driver may have to intervene; Level 4, where all aspects of driving are performed by the driver assistance system, even in situations where the driver does not appropriately respond when requested to intervene; and Level 5, where the vehicle drives fully autonomously with or without a passenger).

In one embodiment of the invention, the steering wheel (102) is equipped with one or more touchpads (104A, 104B). The touchpad(s) may be used to translate the position or motion of a finger on the touchpad's surface into coordinates that may be used to control the alphanumeric user interface. The touchpad(s) may be based on capacitive or conductive sensing, or on any other technology that enables the sensing of a finger's position. While the touchpad(s) may be located anywhere on the steering wheel, in one embodiment of the invention, the touchpad(s) is located near steering wheel rim, e.g., on a spoke of the steering wheel, enabling a driver to operate the touchpad with the thumb, while holding the steering wheel. The touchpad may, thus, be limited in size and may, for example, not be sufficiently large to capture handwriting or other complex finger movement patterns. In one embodiment of the invention, the touchpad is sized to enable the drive to perform basic finger movement patterns such as arcuate or circular motions. Accordingly, the geometry of the touchpad, including size and shape may be limited to the touchpad surface space necessary to perform these basic finger movement patterns. For example, the touchpad surface may be sized not to exceed the range of motion of the driver's thumb as the driver is holding the steering wheel. As an example, each touchpad may be 1.5×2 inches.

The touchpad, in accordance with an embodiment of the invention, includes an electric interface that provides the coordinate signal to a touchpad interface unit (112). The signal may be provided in analog or digital format, without departing from the invention. Further, the coordinate signal may encode different information including, but not limited to, detected x/y position coordinates, force, movement direction and movement velocity. While two touchpads (104A, 104B) are shown in FIG. 1, embodiments of the invention may include any number of touchpads.

In one embodiment of the invention, the system (100) includes a touchpad interface unit (112). The touchpad interface unit receives a coordinate signal from the touchpad(s) (104A, 104B). The touchpad interface unit (112) may further provide an output to one or more other components of the vehicle, as further described below. These components may include, for example, the Vehicle Electronic Control Unit (ECU) (114) and the display interface unit (116). The touchpad interface unit (112) may interface with these other units via a vehicle communication network that interconnects these components, or alternatively via dedicated wiring.

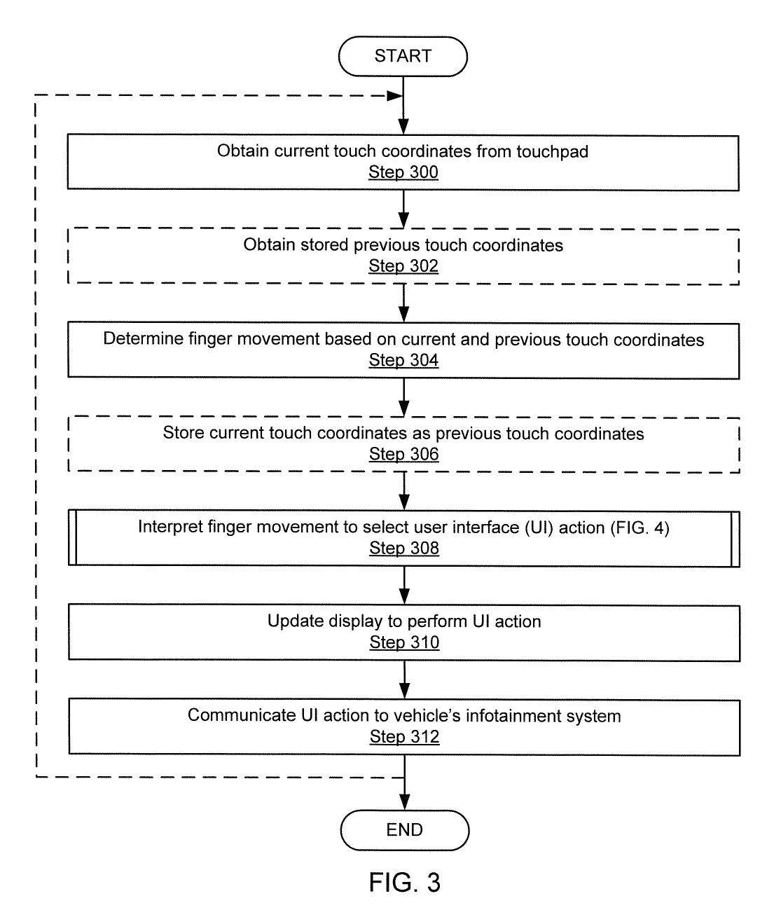

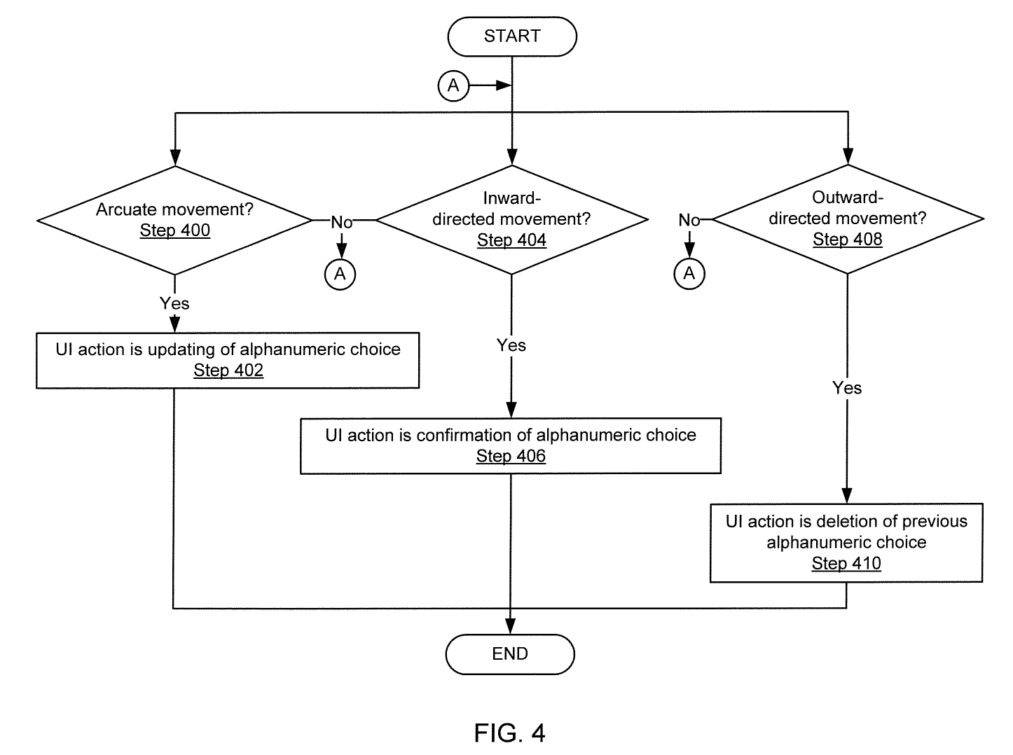

The touchpad interface unit (112) may include a computing device configured to perform one or more of the steps described below with reference to FIGS. 3 and 4. The computing device may be, for example, an embedded system that includes all components of the computing device on a single printed circuit board (PCB), or a single chip (e.g., a system on a chip (SOC)). The computing device may include one or more processor cores, associated memory (e.g., random access memory (RAM), cache memory, flash memory, hard disk, etc.), a network interface (e.g., a local area network (LAN) or any other type of network) via a network interface connection (not shown), and interfaces to storage devices, input and output devices, analog-to-digital and digital-to-analog converters, and numerous other elements and functionalities. In one embodiment of the invention, the computing device includes an operating system that may include functionality to execute the methods further described below. Those skilled in the art will appreciate that the invention is not limited to the aforementioned configuration of the computing device.

In one embodiment of the invention, the system (100) includes a vehicle electronic control unit (ECU) (114). The vehicle ECU is a processing system that links the various interface units (112, 118, 116) to control communications. As an example, if the vehicle ECU hosts the User Interface then it will receive coordinates (x,y) and other information from the Touchpad Interface Unit (112) and send to the Display Interface Unit (116) the relevant change to show in the UI.

Consequently, the Vehicle ECU (114) may send a trigger command to the Haptic Feedback Interface Unit (118). Those skilled in the art will recognize that an ECU may provide or support any of a vehicle's functionalities, without departing from the invention. In one embodiment of the invention, the vehicle ECU is functionally connected with the touchpad interface (112) and/or with the display interface unit (116), e.g., via the vehicle's communication network.

In one embodiment of the invention, the system (100) includes a display interface unit (116). The display interface unit, in one embodiment of the invention, is responsible for rendering the content to be displayed on a display (122) of the system (100), based on received input data. For example, assuming that the display interface unit (116) receives cursor movement data, e.g., from the touchpad interface unit (112), the display interface unit may render the moving cursor, to be displayed on the display (122). The display interface unit may further detect interactions, e.g., of the cursor with other content that is being rendered, as it may occur during the selection of a displayed option or icon using the cursor. In one embodiment of the invention, the display interface unit (116) includes a computing device that may be similar to the previously discussed computing device. The display interface unit (116), in accordance with an embodiment of the invention, is functionally connected with the touchpad interface unit (112), e.g., via the vehicle's communication network.

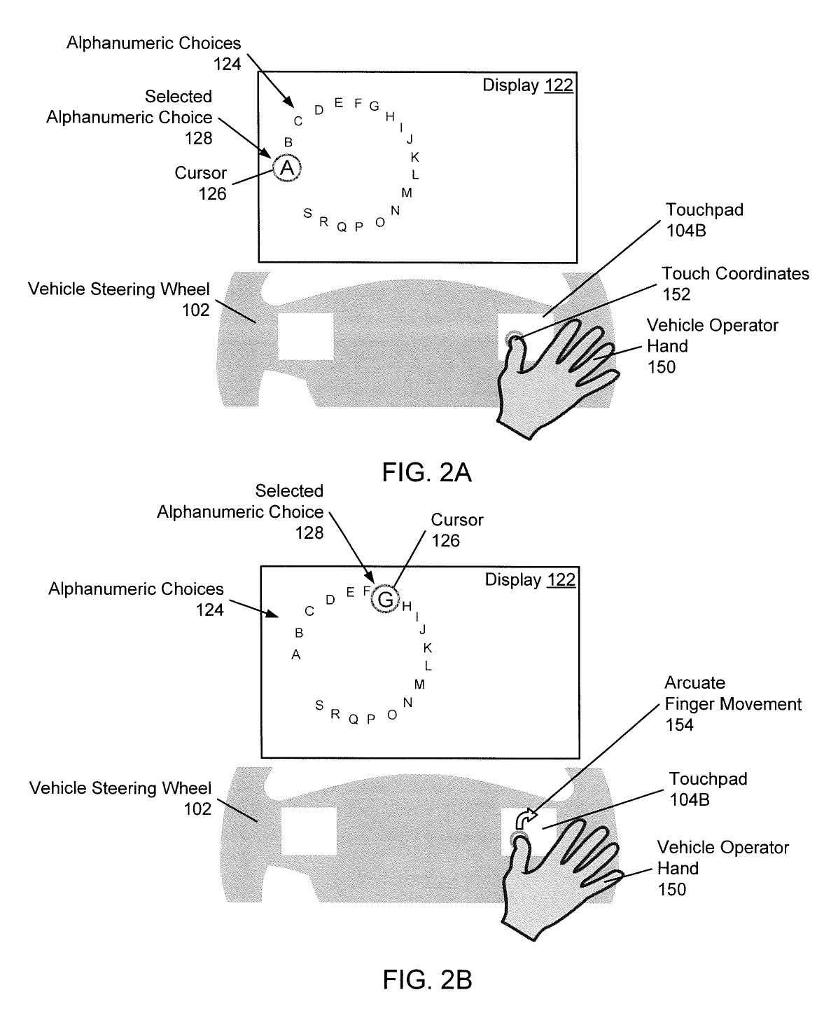

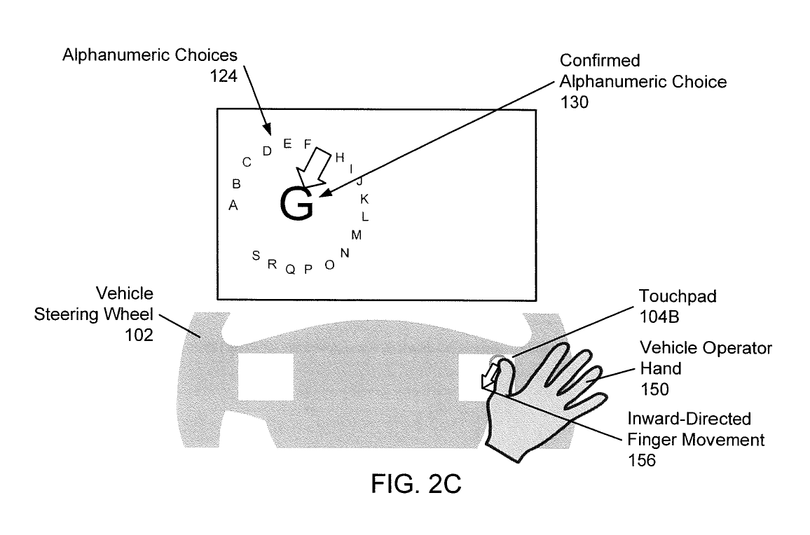

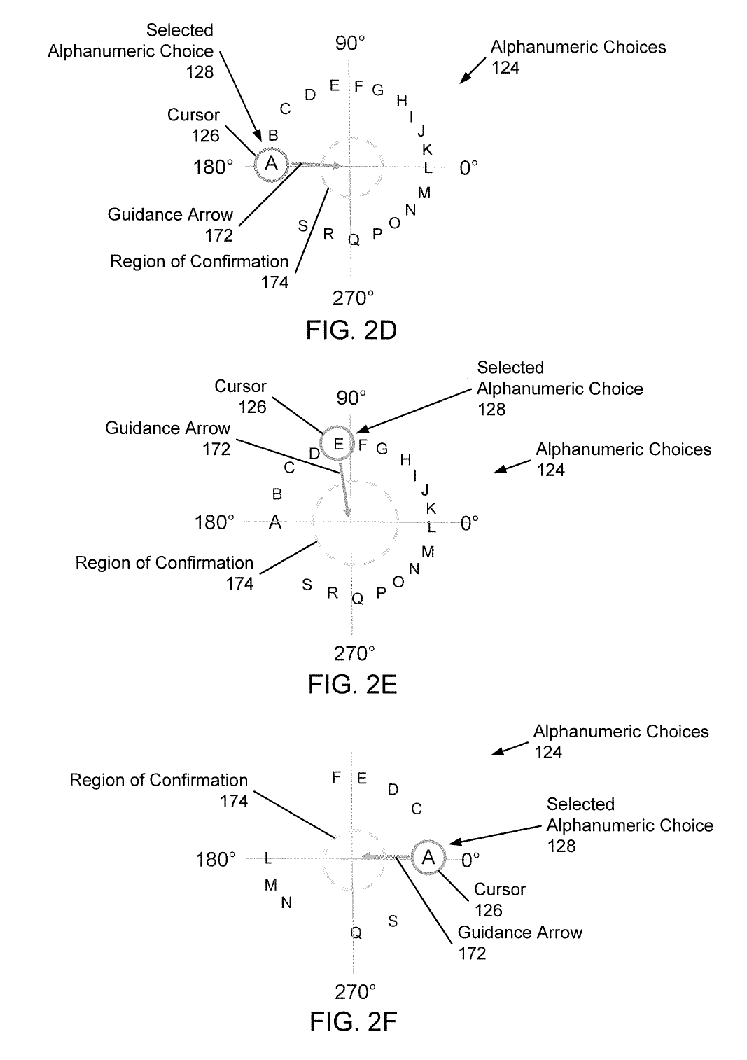

In one embodiment of the invention, the system (100) includes the display (122). The display, in one embodiment of the invention, is configured to display information to the driver of the vehicle. The display (122) may be a screen-based display or a projection-based display. For example, the display may be a screen that is part of the instrument cluster of the vehicle, or it may be a head-up display (HUD). If an HUD is used, the driver may obtain display information without having to shift his or her gaze away from traffic. Any kind of display technology, including, but not limited to liquid crystal display (LCD), light emitting diode (LED) and plasma technologies may be used. Exemplary content that may be displayed when the driver accesses the touch-sensitive alphanumeric user interface (100) is subsequently described with reference to FIGS. 2A-2F.

In one embodiment of the invention, the system (100) further includes a haptic feedback interface unit (118). The haptic interface unit may drive a haptic feedback unit, e.g., one or more actuators (not shown) of the touchpad(s) (104A, 104B), to provide feedback to the driver's hand(s) (150). Such feedback may be, for example, a vibration transmitted to the driver's hand(s) via the contact point between the touchpad(s) (104A, 104B) and the hand(s) (150). Any type of actuator, e.g., an electromagnetic actuator or a piezo actuator, may be used to generate the vibrational feedback.

One skilled in the art will recognize that the architecture of a touch-sensitive alphanumeric user interface is not limited to the components shown in FIG. 1. For example, various components, e.g., the touchpad interface unit (112), the vehicle ECU (114), the display interface unit (116) and/or the haptic feedback interface unit (118) may be combined in a single unit without departing from the invention. Further, any kind of bus system or dedicated connection(s) may be used to interface these units, either directly, or indirectly. One skilled in the art will further appreciate that other vehicle electronic control units may interface with the system, without departing from the invention. One or more embodiments of the invention may further be used in non-vehicle environments. Generally speaking, embodiments of the invention may be used in any scenario that requires a small touch-sensitive input device and a display, separate from the input device. Such scenarios may include, for example, smartwatches used for controlling content on a TV screen, a computer screen, a smartphone display, etc.

FIGS. 2A-2F show the touch-sensitive alphanumeric user interface while being operated by a user, in accordance with one or more embodiments of the invention. In the exemplary scenarios, the touch-sensitive alphanumeric user interface is used to enable the driver to interact with components of the vehicle that require alphanumeric input. Such a scenario may be encountered, for example, when the driver is searching the address book of his/her smart phone that is coupled to the vehicle's infotainment system, when operating the vehicle's navigation system, etc. The touch-sensitive alphanumeric user interface may further be used in any other scenario that requires the input of alphanumeric and/or symbolic content, without departing from the invention.

Turning to FIG. 2A, an exemplary configuration, in which the display (122) is used to present letters in an alphabetical order, is shown. Generally speaking, the display (122) is used to show a number of alphanumeric choices (124), and a cursor (126) marks the current selection of a particular (i.e. selected) alphanumeric choice (128). The cursor (126) is controlled using touch coordinates (152), obtained from the touchpad (104B). Accordingly, the driver may use his hand (150) to operate the touch-sensitive alphanumeric user interface using the touchpad (104B). In the embodiment shown in FIG. 2A, the alphanumeric choices (124) are arranged in a circular pattern, and the cursor (126) is controlled using a arcuate motion on the touchpad. As an example, by tracking a set of x, y coordinates corresponding to the finger's position over time, a line can be estimated for which curvature is calculated. A movements with a curvature greater than a defined threshold (e.g. 0.001 m⁻¹) will be classified as a “circular movement” or as an “arcuate movement”. A circular movement can refer to any portion of a complete circle trajectory without departing from the scope of the present disclosure. While only a single touchpad is being used in the example, additional touchpads may be included in the system as well. For example, a second touchpad may enable the driver to use the left and/or right hand to perform the subsequently described operations.

In FIG. 2A, the driver places his finger on the touchpad, in an approximately 9 o'clock position in order to position the cursor (126) over the letter “A” in the display (122).

In FIG. 2B, the driver performs a clockwise arcuate motion (154) on the touchpad (104B) to control the cursor (126). As the arcuate motion is performed, the touchpad (104B) captures the touch coordinates (152) of the motion to control the cursor (126). Accordingly, the cursor (126) represents the driver's finger position on the touchpad (104B), in accordance with an embodiment of the invention, and in the example advances to the letter “G”. A direct 1:1 mapping between finger position on the touchpad and cursor position on the display may exist. In the exemplary scenario shown in FIG. 2B, a clockwise rotation of the finger on the touchpad results in the cursor advancing through the alphabet in a forward direction, and a counterclockwise rotation of the finger on the touchpad results in the cursor moving through the alphabet in a backward direction. Based on the position of the cursor, a particular letter is selected and highlighted. The highlighting may include an enlarged representation of the letter (using an increased font size), color coding, a change in brightness, etc.

Turning to FIG. 2C, the driver confirms an alphanumeric choice by an inward-directed movement to obtain the confirmed alphanumeric choice (130). In the example, the letter “G” is selected by the driver through movement of the finger toward the center of the arc estimated by the arcuate or circular movement. This inward-directed finger movement may, thus, terminate in approximately the center of the touchpad (104B). The inward-directed finger movement serves as an indication that the current alphanumeric choice is to be confirmed. Depending on the location of the letter being selected, the inward-directed movement may be in a particular direction. For example, if, as illustrated in FIG. 2C, the letter “G” is being selected, the inward-directed movement is downward and slightly to the left. Alternatively, assuming that the letter “A” was selected, the inward-directed movement would be horizontally to the right. Generally speaking the inward-directed movement may be performed in an approximately radial direction relative to the arcuate finger movement at the point where the alphanumeric choice to be confirmed is located. In one or more embodiments of the invention, the required distance of the inward-directed movement is configurable. For example, a relatively short inward-directed movement may be sufficient to indicate confirmation in one configuration, while in another configuration, a relatively long inward-directed movement (e.g., reaching approximately the center of the touchpad) may be required to indicate confirmation. The confirmed alphanumeric choice may be shown in the display. For example, the letter “G” may be prominently shown in the center of the circular, alphabetical pattern, as illustrated in FIG. 2C. Further, the confirmed choice may be added to a word or phrase that the driver is completing using the touch-sensitive alphanumeric interface.

Turning to FIGS. 2D-2F, additional details of the touch-sensitive alphanumeric user interface are shown. Alphanumeric choices (124) are displayed, while the user is operating the Touchpad (104B). Assume that, in FIG. 2D, the user intends to select letter “A”. Accordingly, the selected alphanumeric choice (128) is the letter “A”, highlighted by the cursor (126). The user may now confirm the letter “A” by performing an inward-directed movement in the touchpad (104B). Due to the location of the letter “A”, the direction of the inward-directed movement is in an approximately 0° direction, as illustrated in FIG. 2D. The inward-directed movement that may lead to the confirmation of the selected alphanumeric choice (128) is illustrated by a guidance arrow (172). The guidance arrow may be shown in the display (122) to instruct the user how to correctly make the selection by performing the inward-directed movement on the touchpad (104B). The amplitude of the inward-directed movement may be selected such that a region of confirmation (174) is reached, in order to successfully complete the confirmation of the selected alphanumeric choice. In one or more embodiments of the invention, the sensitivity for the detection of an inward-directed movement is adjustable by scaling the region of confirmation (174). A higher sensitivity is obtained when using a comparatively small region of confirmation, whereas a lower sensitivity is obtained when using a comparatively large region of confirmation. While in FIG. 2D, a higher sensitivity configuration (smaller region of confirmation) is shown, FIG. 2E shows a lower sensitivity configuration (larger region of confirmation). Accordingly, in order to confirm the letter “E”, a shorter amplitude movement in an approximately 270° direction may be sufficient due to the lower sensitivity configuration. As the user makes an inward-directed movement in the Touchpad (104B) the selected alphanumeric choice (128) shown in the Display (122) is also updated to move in the direction of the inward-directed movement until it crosses the Region of Confirmation (174). In the above scenarios, both the direction of the inward-directed movement and the termination of the inward-directed movement in the region of confirmation (174) may be used for confirmation of the Selected Alphanumeric Choice (128).

FIG. 2F shows an embodiment in which the alphanumeric choices are arranged in a counterclockwise order. Only a subset of alphanumeric choices is displayed. This may be a result of limiting the display of alphanumeric choices, e.g., based on an auto-complete feature that proposes only alphanumeric choices that are meaningful within the context of the entry the user is performing, as further described below. In the example of FIG. 2F, the sensitivity of the detection of an inward-directed movement is comparatively high, similar to the configuration shown in FIG. 2D. Accordingly, to confirm the selection of the letter “A”, the user would have to perform an inward-directed movement of an amplitude sufficient to reach the region of confirmation. The inward-directed movement would be in an approximately 180° direction, as indicated by the guidance arrow.

In one embodiment of the invention, the user receives a visual confirmation on the display once an inward-directed movement is successfully detected, based on the proper angle and amplitude of the movement, as described above. The visual confirmation may include, for example, an animation such as a movement of the selected alphanumeric choice in the direction of the guidance arrow. The animation may then, for example, show the confirmed alphanumeric choice in the center of the circular arrangement of the alphanumeric choices (124) in the display (122).

Those skilled in the art will appreciate that the invention is not limited to the input patterns described in FIGS. 2A-2F. For example, the above-described steps may be repeated to select additional letter, e.g., to form entire words or sentences. Further, selections may be performed for non-alphabetical content such as numbers and or symbols. Also, only a partial alphabet may be presented to the user to support an accelerated operation of the touch-sensitive alphanumeric user interface. Consider, for example, the use of the interface to navigate through contacts. The accessed contact list only includes names starting with the letters A-D and J-L. Accordingly, the interface may not present the letters E-I and M-Z when letting the driver enter the first letter of the contact. Those skilled in the art will appreciate that the finger with which alphanumeric choice is made may be a thumb, or any other finger that may be suitable for the driver to operate the touchpad. Further, although FIGS. 2A-2F show the alphanumeric choices arranged in a circular pattern, any suitable shaped pattern of choices may be displayed on the display. For example, the system may be configured to accept non-arcuate movement patterns such as swiping movements, taps, etc., without departing from the invention.

FIG. 3 shows a flowchart in accordance with one or more embodiments of the invention. The process depicted in FIG. 3 may be used to obtain alphanumeric input from a driver of a vehicle, in accordance with one or more embodiments of the invention. One or more of the steps in FIG. 3 may be performed by the components of the system (100), discussed above in reference to FIG. 1. In one embodiment of the invention, at least one of the steps shown in FIG. 3 is performed by the touchpad interface unit (112) and/or the display interface unit (116), shown in FIG. 1. The touchpad interface unit and/or the display interface unit may thus include software instructions that implement the method shown in FIG. 3. One or more of the steps shown in FIG. 3 may be performed whenever the driver operates the touchpad.

In one or more embodiments of the invention, one or more of the steps shown in FIG. 3 may be omitted, repeated, and/or performed in a different order than the order shown in FIG. 3. Accordingly, the scope of the invention should not be considered limited to the specific arrangement of steps shown in FIG. 3.

In Step 300, the current touch coordinates are obtained from the touchpad. The current touch coordinates may be two-dimensional position signals (x, y) which may further include a force signal in the third dimension. The current touch coordinates may be provided in any form, for example, as analog or digital signals. Based on a calibration that may have been previously performed, these signals may be translated into the touch coordinates.

In Step 302, previously stored touch coordinates are obtained from memory. While this step is optional, it may be performed to derive velocity or direction signals, as described in Step 304. In one example, previously stored touch coordinates may not be available when the driver's finger initially comes in contact with the touchpad. In this case, the first set of touch coordinates obtained in Step 300 may be stored as the previous touch coordinates during an initialization.

In Step 304, the finger movement is determined. Finger movement may be represented by various signals. For example, the finger movement obtained in FIG. 304 may be a position signal. In this case, the current touch coordinates, obtained in Step 300, may be used. Specifically, because the displayed user interface content, such as characters available for selection, is mapped to the touchpad, the 2D position coordinates from Step 300 may be compared with a location of, e.g., characters displayed to the driver, such that selections of characters can be made, based on finger position on the touchpad, as further described below. Alternatively, other representations may be used, including but not limited to, velocity signals, direction signals and combinations thereof. Such representations may be obtained using a combination of the current touch coordinates and the previous touch coordinates, e.g., by performing a numerical differentiation to obtain a velocity.

In Step 306, the current touch coordinates are stored as the updated previous touch coordinates. Analogous to Step 302, Step 306 is also optional and may only be necessary if previous touch coordinates are used to obtain finger movement.

In Step 308, the finger movement is interpreted to obtain a user interface (UI) action. In one or more embodiments, the interpretation of the finger movement involves determining the type of the movement in order to decide how the display is to be updated, based on the finger movement. The details of Step 308 are provided below, with reference to FIG. 4.

In Step 310, the display is updated to show the user interface action that was determined in Step 308. The updating of the display, in accordance with one or more embodiments of the invention, involves rendering a screen output that reflects changes in the displayed content. The rendering may involve a particular alphanumeric choice being highlighted, to indicate that the alphanumeric choice has been selected, based on the finger movement, and/or may involve showing that an alphanumeric choice has been confirmed, etc. Essentially, any displayable change, based on the steps described in FIG. 4, may result in an updated rendering of the display content, as previously described, for example, with reference to FIGS. 2A-2F.

In Step 312, a UI action is communicated to the vehicle's infotainment system. The communicated UI action may be for example, the selection of a letter, the deletion of a letter, etc. The communication of the UI action, in accordance with an embodiment of the invention, is context-specific. For example, if the touch-sensitive alphanumeric input device is used to navigate a contact library, a selected contact may be communicated to the driver's smartphone. Alternatively, if a street address is selected, the selected street address may be communicated to the vehicle's navigation system.

After completion of the above-described steps, the method may return to Step 300, e.g., to obtain additional user input. This additional user input may be directed to the same or to a different component of the vehicle. For example, a first execution of the method may be used to program a destination into the vehicle's navigation system, whereas a second execution of the method may be used to dial a telephone number via a smartphone interfacing with the vehicle electronic system.

FIG. 4 shows a flowchart illustrating a method for interpreting detected finger movement to obtain a user interface (UI) action, in accordance with one or more embodiments of the invention. The method of FIG. 4 includes the detection of various types of UI actions. During the execution of the method of FIG. 4, one of these UI actions may be detected. However, the execution of FIG. 4 may also result in the detection of none of the shown UI actions, for example, when a finger movement cannot be identified as representing a particular UI action. Those skilled in the art will recognize that while FIG. 4 only shows three UI actions, the system may support any number of UI actions. Additional UI actions may involve other finger movements that the system is programmed to recognize. These finger movements may involve any kind of touchpad input that the touchpad is configured to recognize. For example, not only sliding finger movements, but also tapping, and/or the application of different/variable forces may be recognized. In addition, multi-finger movements such as gestures may also be supported. UI actions and their corresponding finger movements may be pre-programmed, e.g., by the vehicle manufacturer or seller, the original equipment manufacturer of the touch-sensitive alphanumeric user interface, and/or they may be programmed by the driver, using a training procedure that involves, for example, recording a particular finger movement and assigning it to a specific UI action.

Before the steps of FIG. 4 take place, the user may have already selected a function from the various applications that may be a part of the vehicle infotainment system. For example, the user may select radio, media, phone, navigation, etc. Further, the user may also touch one of the touchpads to start input function. This may be a pre-configuration option to use either the left or the right touchpad when more than one touchpad is present on the steering wheel.

In Step 400, a determination is made about whether the finger movement represents an arcuate movement. The determination may be made based on the finger's trajectory, e.g., the finger's movement over time. Finger position, velocity, and/or movement direction may be considered. If no arcuate movement is detected, no action is taken. However, if an arcuate movement is detected, the method, in Step 402, may conclude that the updating of the alphanumeric choice is the UI action requested by the driver. Specifically, for example, referring to FIGS. 2A and 2B, the clockwise arcuate finger movement results in the selected alphanumeric choice to be updated from originally “A” to “G”. How exactly the updating of the UI action is performed may depend on the finger movement performed by the driver. For example, while the finger movement illustrated in FIG. 2B advances the selected alphanumeric choice from letter “A” to letter “G”, a small arcuate finger movement would have advanced the alphanumeric choice to a lesser degree, e.g., from letter “A” to letter “B”. In one or more embodiments of the invention, as the selected alphanumeric choice is updated, haptic feedback is provided to the driver, e.g., in the form of a brief vibration of the touchpad.

In Step 404, a determination is made about whether the finger movement represents an inward-directed movement. The determination may be made based on the finger's trajectory, e.g., the finger's movement over time. Finger position, velocity, and/or direction may be considered. More specifically, an inward-directed movement may be understood as a movement that begins at the touchpad location where an alphanumeric character is selected, and that is performed in a radial direction relative to the previously executed arcuate finger movement. Further, the required distance of the inward-directed movement may be configurable, as previously discussed with reference to FIGS. 2D and 2E. If no inward-directed movement is detected, no action is taken. However, if an inward-directed movement is detected, the method, in Step 406, may conclude that a confirmation of the current alphanumeric choice is the UI action requested by the driver. Specifically, for example, referring to FIG. 2C, the inward-directed finger movement results in the selection of the letter “G”. The finger may remain in constant contact with the touchpad, for the entire process of making an alphanumeric choice (Steps 400 and 402), and the confirmation of the alphanumeric choice (Steps 404 and 406). Accordingly the detected finger movement may include an arcuate movement, immediately followed by the inward-directed movement. In one or more embodiments of the invention, as an inward-directed movement is detected, haptic feedback is provided to the driver, e.g., in the form of a brief vibration of the touchpad.

In Step 408, a determination is made about whether the finger movement represents an outward-directed movement. The determination may be made based on the finger's trajectory, e.g., the finger's movement over time. Finger position, velocity, direction and/or other parameters may also be considered. As an example, an outward-directed movement can occur in two scenarios when the user wants to delete a previously confirmed alphanumeric choice. When the user uses the right touchpad and right hand, the two scenarios may be as follows: In one embodiment, the first scenario corresponds to performing an outward-directed movement half-way through executing an arcuate movement (e.g., to select the next alphanumeric choice). In this scenario, an outward-directed movement may be detected when the user's finger moves outside of the arc estimated by the current arcuate movement. In another embodiment, the second scenario corresponds to performing an outward-directed movement before making an arcuate movement (e.g., to select the next alphanumeric choice) in order to delete the previously confirmed alphanumeric choice. In this scenario, an outward-directed movement may be detected as a movement that begins in any location of the touchpad (e.g., the first coordinates), and ends to the left of the vertical axis centered on the first coordinates. The outward-directed movement may be performed in any direction, e.g., in a horizontal or vertical direction, or in any other outward direction. If no outward-directed movement is detected, no action is taken. However, if an outward-directed movement is detected, the method, in Step 410, may conclude that a deletion of the previous alphanumeric choice is the UI action requested by the user. In one or more embodiments of the invention, as an outward-directed movement is detected, haptic feedback is provided to the user, e.g., in the form of a brief vibration of the touchpad.

One skilled in the art will recognize that a single execution of the above-described flowchart may result in the selection (or deletion) of a single character.

In order to enter a series of characters, e.g., an entire name, repeated execution of the flowcharts may be necessary. Consider, for example, a scenario in which the driver intends to enter the name “David” to locate David's phone number while driving. During the first execution of the methods of FIGS. 3 and 4, the letter “D” is selected. In order to select the next letter, “a”, the driver briefly lifts off his finger from the touchpad, and subsequently bring his finger back in contact with the touchpad, e.g., in a peripheral location. A renewed execution of the flowcharts of FIGS. 3 and 4 is, thus, triggered, and the methods of FIGS. 3 and 4 may be repeatedly invoked until the driver has entered the entire name “David”, or alternatively, until an auto-complete feature of the system determines that the driver is looking for the contact “David” based on a partially entered name.

Those skilled in the art will appreciate that the invention is not limited to the above scenario. For example, a renewed execution of the methods may require the positioning of the finger in a particular location on the touchpad, or it may be sufficient to place the finger in any location on the touchpad. In one or more embodiments of the invention, what constitutes a particular finger movement, what triggers renewed execution of the methods, and/or what actions are assigned to particular finger movements is configurable, e.g., by the driver, but the vehicle manufacturer and/or by the original equipment manufacturer of the touch-sensitive alphanumeric user interface.

In one or more embodiments of the invention, the above-described methods may also be used to perform a mode selection in addition to, or as an alternative to, entering alphanumeric content. For example, the methods may be used to select between various modes of the infotainment system, e.g., a media playback mode, a navigation system mode, a telephone mode, etc. If the system includes multiple touchpads, such as shown in FIG. 1, one touchpad may be assigned to mode selection and the other touchpad may be assigned to entering alphanumeric content. The role of the touchpad (e.g., the assignment of the touchpad(s) to mode selection and/or entering alphanumeric content) may be configurable, e.g., based on the driver's preferences.

Various embodiments of the invention have one or more of the following advantages. A touch-sensitive alphanumeric user interface in accordance with one or more embodiments of the invention enables a user to enter alphanumeric content in an effortless manner. In particular, the user does not need to look at the touchpad while entering the content. This configuration may, therefore, be particularly beneficial in applications that require a user to attend to a task, such as driving a vehicle. In one or more embodiments of the invention, the touchpad(s) is ergonomically located on the steering wheel, thus enabling the driver to provide alphanumeric input without having to release the steering wheel. The display, on the other hand, is located in the dashboard or in a head-up display, thus allowing the driver to primarily focus on the driving task, while still being able to see the alphanumeric input being provided via the touchpad. Further, due to the basic geometric patterns being used as an input for controlling the touch-sensitive alphanumeric user interface, the touchpad can be of limited size, thus providing flexibility in the placement of the touchpad.

Advantageously, the invention allows a driver, in one example, to be capable of typing text within a small surface on the steering wheel with his/her thumb.

While the technology has been described with respect to a limited number of embodiments, those skilled in the art, having benefit of this disclosure, will appreciate that other embodiments can be devised which do not depart from the scope of the technology as disclosed herein. Accordingly, the scope of the technology should be limited only by the attached claims.

What is claimed is:

1. A touch-sensitive alphanumeric user interface for a vehicle, comprising:
a first touchpad, integrated in a steering wheel of the vehicle, and configured to obtain first coordinates of a first trajectory performed by a finger of a user of the vehicle;
a touchpad interface unit configured to:
make a first determination that a first finger movement, identified from the first coordinates, is an arcuate movement, and based on the first determination, issue arcuate movement instructions to a display interface unit;
the display interface unit configured to:
render a visualization of a plurality of alphanumeric choices, arranged in a circular pattern;
determine a selected alphanumeric choice from the plurality of alphanumeric choices, based on the arcuate movement instructions;
render the selected alphanumeric choice to be highlighted; and
a display, spatially separate from the first touchpad, configured to:
display the rendered visualization of the plurality of alphanumeric choices and of the selected alphanumeric choice.

2. The touch-sensitive alphanumeric user interface of claim 1,
wherein the first touchpad is further configured to, after the obtaining of the first coordinates:
obtain second coordinates of a second trajectory performed by the finger of the user;
wherein the touchpad interface unit is further configured to:
make a second determination that a second finger movement, identified from the second coordinates, is a radially inward-directed movement, relative to the arcuate movement, and based on the second determination, issue confirmation instructions to the display interface unit;
wherein the display interface unit is further configured to:
render a visual confirmation of the selected alphanumeric choice, based on the confirmation instructions; and
wherein the display is further configured to:
display the visual confirmation.

3. The touch-sensitive alphanumeric user interface of claim 2,
wherein the display interface unit is further configured to communicate the selected alphanumeric choice to an infotainment system of the vehicle.

4. The touch-sensitive alphanumeric user interface of claim 2,
wherein the first touchpad is further configured to, after the obtaining of the second coordinates:
obtain third coordinates of a third trajectory performed by the finger of the user;
wherein the touchpad interface unit is further configured to:
make a third determination that a third finger movement, identified from the third coordinates, is an outward-directed movement towards a peripheral region of the first touchpad, and based on the third determination, issue instructions to delete the confirmed selected alphanumeric choice to the display interface unit;
wherein the display interface unit is further configured to:
render the confirmed selected alphanumeric choice being deleted; and
wherein the display is further configured to:
display the deletion of the confirmed selected alphanumeric choice.

5. The touch-sensitive alphanumeric user interface of claim 1, further comprising a haptic feedback unit configured to provide a vibratory feedback to the user, via the touchpad, after the selected alphanumeric choice is determined.

6. The touch-sensitive alphanumeric user interface of claim 1,
wherein the highlighting of the selected alphanumeric choice in the display comprises increasing a font size of the selected alphanumeric choice.

7. The touch-sensitive alphanumeric user interface of claim 1, wherein a surface of the first touchpad is sized not to exceed a range of motion of a thumb of the user.

8. The touch-sensitive alphanumeric user interface of claim 1, wherein the first touchpad is located near a steering wheel rim, configured to be operated by a first thumb of the user, and wherein the user is a vehicle driver holding the steering wheel.

9. The touch-sensitive alphanumeric user interface of claim 8, further comprising a second touchpad, configured to be operated by a second thumb of the driver.

10. The touch-sensitive alphanumeric user interface of claim 9, wherein the second touchpad is configured to enable the driver to perform a mode selection of an infotainment system of the vehicle.

11. The touch-sensitive alphanumeric user interface of claim 10, wherein roles of the first and the second touchpads in controlling an infotainment system are configurable.

12. The touch-sensitive alphanumeric user interface of claim 1, wherein the display comprises a head-up display.

13. The touch-sensitive alphanumeric user interface of claim 1, wherein the plurality of alphanumeric choices, rendered in the display in the circular pattern, are in sequential order.

14. The touch-sensitive alphanumeric user interface of claim 1, wherein a one-to-one spatial mapping exists between the touch by the finger on the touchpad and the selected alphanumeric choice on the circular pattern formed by the plurality of alphanumeric choices.

15. A method for operating an infotainment system of a vehicle, the method comprising:
obtaining, using a first touchpad that is integrated in a steering wheel of the vehicle, first coordinates of a first trajectory performed by a finger of a user of the vehicle;
making a first determination that a first finger movement, identified from the first coordinates, is an arcuate movement, and based on the first determination, issue arcuate movement instructions;
rendering a visualization of a plurality of alphanumeric choices, arranged in a circular pattern;
determining a selected alphanumeric choice from the plurality of alphanumeric choices, based on the arcuate movement instructions;
rendering the selected alphanumeric choice to be highlighted; and
displaying the rendered visualization of the plurality of alphanumeric choices and of the selected alphanumeric choice in a display.

16. The method of claim 15, further comprising, after the obtaining of the first coordinates:
obtaining, using the first touchpad, second coordinates of a second trajectory performed by the finger of the user;
making a second determination that a second finger movement, identified from the second coordinates, is a radially inward-directed movement relative to the arcuate movement, and based on the second determination, issue confirmation instructions;
rendering a visual confirmation of the selected alphanumeric choice, based on the confirmation instructions; and
displaying the visual confirmation in the display.

17. The method of claim 16, further comprising communicating the selected alphanumeric choice to the infotainment system of the vehicle.

18. The method of claim 16, further comprising, after the obtaining of the second coordinates:
obtaining third coordinates of a third trajectory performed by the finger of the user;
making a third determination that a third finger movement, identified from the third coordinates, is an outward-directed movement towards a peripheral region of the first touchpad, and based on the third determination, issue instructions to delete the confirmed selected alphanumeric choice;
rendering the confirmed selected alphanumeric choice being deleted; and
displaying the deletion of the confirmed selected alphanumeric choice in the display.

19. The method of claim 15, further comprising providing a vibratory feedback to the user, via the first touchpad, after the selected alphanumeric choice is determined.

20. The method of claim 15, further comprising, obtaining, using a second touchpad, a mode selection of the infotainment system of the vehicle.
